(19) United States
(12) Patent Application Publication
(10) Pub. No.: US 2024/0178905 A1
(43) Pub. Date: May 30, 2024

(54) RELAY DEVICE, TERMINAL DEVICE, AND CONTROL METHOD FOR IMPROVING POSITION ESTIMATION ACCURACY, AND COMPUTER-READABLE STORAGE MEDIUM

(71) Applicant: KDDI CORPORATION, Tokyo (JP)

(72) Inventors: Hiroki KOTAKE, Tokyo (JP); Masaya SHIBAYAMA, Tokyo (JP)

(21) Appl. No.: 18/435,585

(22) Filed: Feb. 7, 2024

Related U.S. Application Data
(63) Continuation of application No. PCT/JP2023/003751, filed on Feb. 6, 2023.

(30) Foreign Application Priority Data
Feb. 16, 2022 (JP) 2022-022190

(51) Int. Cl. H04B 7/15; H04L 5/00; H04W 64/00

(52) U.S. Cl. CPC H04B 7/15; H04L 5/0007; H04W 64/003

(57) ABSTRACT

A relay device that relays a wireless signal received from a base station device to a terminal device performs control so that, when a predetermined signal generated using a first sequence is received from the base station device, the predetermined signal corresponding to a signal generated using a second sequence corresponding to the first sequence and not to be used by the base station device to generate the predetermined signal is relayed to the terminal device.

### CROSS-REFERENCE TO RELATED APPLICATION(S)

This application is a continuation of International Patent Application No. PCT/JP2023/003751 filed on Feb. 6, 2023, which claims priority to and the benefit of Japanese Patent Application No. 2022-022190 filed on Feb. 16, 2022, the entire disclosures of which are incorporated herein by reference.

### BACKGROUND OF THE INVENTION

### Field of the Invention

The present invention relates to a position estimation technique in a wireless communication system that employs a relay device.

### Description of the Related Art

With a wireless communication system, by specifying the position of a terminal device, it is possible to provide the terminal device with a communication service in accordance with the position. For example, the terminal device may use the Global Navigation Satellite System (GNSS) to determine the position thereof by measuring radio waves transmitted from an artificial satellite, and report this information to the network via a base station device. On the other hand, there may be cases where the terminal device cannot use GNSS positioning, or where the GNSS positioning function is disabled. In such cases, for example, it is possible to use a method in which the terminal device measures radio waves transmitted from a plurality of base station devices and estimates the position of the terminal device based on the time of arrival (propagation time) and direction of arrival of the radio waves.

In a cellular communication system, a relay device (for example, a wireless repeater) that amplifies the radio waves received from a base station device or a terminal device and outputs the amplified radio waves may be used to increase the communicable area. If a relay device is used, the relay operation performed within the relay device may increase the delay for radio waves transmitted from the base station device to reach the terminal device. Due to this delay, it may be determined that the base station device is located farther from the terminal device than the actual position thereof, and as a result, the positioning error of the terminal device may become very large.

### SUMMARY OF THE INVENTION

The present invention provides a technique for improving positioning accuracy in a wireless communication system in which a relay device is used.

According to one aspect of a present invention, there is provided a relay device that relays a wireless signal received from a base station device to a terminal device, the relay device comprising: one or more processors; and one or more memories that store a computer-readable instruction for causing, when executed by the one or more processors, the one or more processors to function as: a control unit configured to control the relay device so that, when the relay device receives a predetermined signal generated using a first sequence from the base station device, the relay device relays to the terminal device the predetermined signal corresponding to a signal generated using a second sequence corresponding to the first sequence and not to be used by the base station device to generate the predetermined signal.

According to one aspect of a present invention, there is provided a terminal device comprising: one or more processors; and one or more memories that store a computer-readable instruction for causing, when executed by the one or more processors, the one or more processors to function as: a detection unit configured to detect a predetermined signal arriving at the terminal device; and an estimation unit configured to estimate a position of the terminal device based on the predetermined signal thus detected and a position of a base station device from which the predetermined signal is transmitted, wherein, when the predetermined signal generated using a first sequence is detected, the estimation unit estimates the position of the terminal device using a time of detection of the predetermined signal, and when the predetermined signal corresponding to a signal generated using a second sequence related to the first sequence and not to be used by the base station device to generate the predetermined signal is detected, the estimation unit estimates the position of the terminal device by correcting the time of detection so as to indicate that the predetermined signal has arrived at the terminal device earlier than the time of detection of the predetermined signal by a time related to relay processing performed by a relay device.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a configuration of a wireless communication system.

FIG. 2 is a diagram illustrating an example of PSS relay processing.

FIG. 3 is a diagram showing example of hardware configurations of a relay device and a terminal device.

FIG. 4 is a diagram showing an example of a functional configuration of the relay device.

FIG. 5 is a diagram showing an example of a functional configuration of the terminal device.

FIG. 6 is a diagram showing an example of a flow of processing performed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

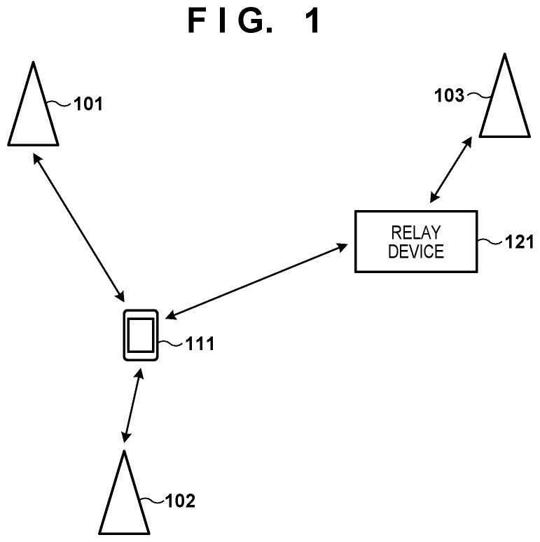

FIG. 1 shows an example of a configuration of a wireless communication system according to the present embodiment. This wireless communication system may be a cellular communication system that complies with Long Term Evolution (LTE) or 5th Generation (5G) cellular communication standards, in which a terminal device connects to a base station device and performs wireless communication. Note that the wireless communication system employs a relay device to improve wireless quality at cell edges and in dead zones. Note that FIG. 1 shows an example in which base station devices 101 to 103 and a terminal device 111 are present, and a relay device 121 is provided to relay communication performed by the base station device 103, for example. The terminal device 111 is configured to be able to connect to and communicate with any of the base station devices 101 to 103. Note that, when connecting to the base station device 103, the terminal device 111 establishes a connection via the relay device 121. Note that the relay device 121 may be, for example, a non-regenerative relay device (wireless repeater) that amplifies and outputs received signals without performing demodulation or the like thereon.

In the wireless communication system, the terminal device 111 detects predetermined signals respectively transmitted from the base station devices 101 to 103, and estimates the position of the terminal device 111 itself based on the times of detection of the signals. The terminal device 111 can estimate the position of the terminal device 111 itself based on the positions of three or more base station devices (for example, the base station devices 101 to 103) and differences between the times of detection of the predetermined signals transmitted from the base station devices, i.e., Time Differences Of Arrival (TDOA).

On the other hand, the terminal device 111 receives a predetermined signal transmitted from the base station device 103, via the relay device 121. Therefore, for example, due to delays in the processing performed by the relay device 121 such as amplification and output, the time until the predetermined signal transmitted from the base station device 103 is received by the terminal device 111 no longer corresponds to the length of the propagation path of radio waves between the terminal device 111 and the base station device 103 via the relay device 121, and the error in the estimation result of the position of the terminal device 111 becomes large. However, if the terminal device 111 can detect that the predetermined signal has arrived at the terminal device 111 via the relay device 121, the time of reception of the predetermined signal by the terminal device 111 can be corrected to indicate that the predetermined signal arrived at the terminal device 111 earlier by the period corresponding to the processing delay at the relay device 121. This corrected time is the time corresponding to the length of the propagation path of radio waves between the terminal device 111 and the base station device 103 via the relay device 121. In this case, the terminal device 111 can perform position estimation by assuming that the predetermined signal from the base station device 103 directly arrived at the terminal device 111 at the corrected time, for example. In addition, the terminal device 111 may, for example, correct the corrected time to a time that is further earlier by a time corresponding to the distance between the base station device 103 and the relay device 121, and assume that the predetermined signal transmitted from the relay device 121 arrived at the terminal device 111 at the re-corrected time. Thus, the terminal device 111 can improve the position estimation accuracy by estimating the position thereof based on the differences between the times of reception of the predetermined signals received from the base station device 101, the base station device 102, and the relay device 121.

On the other hand, if the relay device 121 is a wireless repeater configured to amplify the received wireless signals and output the amplified signals without demodulating the signals, the terminal device 111 cannot distinguish whether the signals arriving at the terminal device 111 are signals arriving directly from the base station device 103 or signals arriving via the relay device 121. Therefore, the terminal device 111 cannot correct the reception times appropriately. In the present embodiment, in view of such circumstances, the relay device 121 performs processing to enable the terminal device 111 to detect whether the signals arriving at the terminal device 111 are signals arriving directly from the base station device 103 or signals arriving via the relay device 121, so that the terminal device 111 can correct the reception time appropriately.

The relay device 121 in the present embodiment, when receiving a predetermined signal from the base station device 103, performs predetermined processing on the signal and transmits it instead of amplifying and outputting the signal unchanged. For example, the predetermined signal transmitted from the base station device 103 is generated using a first sequence. In this case, if the predetermined signal arrives at the terminal device 111 at a predetermined power level or higher, the terminal device 111 can detect the predetermined signal using the first sequence. In the present embodiment, the relay device 121 is also enabled to detect the predetermined signal using the first sequence. When the relay device 121 receives a predetermined signal generated using this first sequence, the relay device 121 relays a predetermined signal generated using a second sequence that corresponds to the first sequence and is different from the first sequence. Here, the second sequence may be a sequence that is not used when a predetermined signal is transmitted by the base station device 103. As a result, if the terminal device 111 detects a predetermined signal using the first sequence, the terminal device 111 can determine that the predetermined signal has arrived directly from the base station device 103, and if the terminal device 111 detects a predetermined signal using the second sequence, the terminal device 111 can determine that the predetermined signal has arrived via the relay device 121.

Note that the base station device 103 uses the first sequence when transmitting a predetermined signal, but the sequence that can be used as the first sequence may have a plurality of patterns. For example, if the predetermined signal is a primary synchronization signal (PSS), the base station device 103 may use a predetermined sequence prepared in advance as the first sequence as is, or use a sequence generated by applying a cyclic shift with a predetermined shift amount to the predetermined sequence as the first sequence. Note that a cyclic shift is performed by changing the starting position of a predetermined sequence and adding a partial sequence that is present before the starting position to the end of the sequence. For example, applying a cyclic shift with a shift amount of 10 to a sequence with a length of 100, in which any of the indexes from 0 to 99 is added to each symbol, results in a sequence whose starting position is 10 and in which partial sequences with indexes from 0 to 9 are added after the symbol with the index 99. Here, for a PSS, three types of shift amounts are defined for a Zadoff-chu sequence with a length of 127, namely (1) no shift (shift amount=0), (2) shift amount=43, and (3) shift amount=86. Therefore, when a PSS is used as a predetermined signal, one of three types of sequences corresponding to these shift amounts is used as the first sequence. On the other hand, the relay device 121 can use a sequence that is different from any of the three types of sequences as the second sequence. Note that 3×N (N≥1) types of second sequences that correspond to three types of first sequences may be provided, for example. The relay device 121 may determine which of the three types of first sequences was used to generate the signal received from the base station device 103, and select a sequence to be used from the N types of second sequences corresponding to the specified sequence, generate a predetermined signal for the selected sequence, and transfer the predetermined signal to the terminal device 111. Note that the second sequence may be a sequence that is irrelevant to the predetermined sequence used to generate the first sequence. In addition, in an example, the second sequence may be a sequence that is orthogonal to the predetermined sequence used to generate the first sequence. As a result of preparing second sequences corresponding to a plurality of sequences that can be used as the first sequence, it is possible to determine to which of the plurality of sequences that can be used as the first sequence the predetermined signal detected at the terminal device 111 corresponds, and to determine the predetermined signal transmitted by which base station device the predetermined signal detected at the terminal device 111 corresponds to.

Note that, as described above, the predetermined signal may be a PSS. In this case, the first sequence is a sequence obtained by applying a cyclic shift with a first shift amount (shift amount=0, 43, or 86) to the predetermined sequence as described above. In this case, a sequence obtained by applying a cyclic shift with a second shift amount, which cannot be taken as the first shift amount, to the predetermined sequence may be used as the second sequence. For example, when the first shift amount is 0, the second shift amount associated with the first shift amount may be set to 9, 18, or 27. When the first shift amount is 43, the second shift amount associated with the first shift amount may be set to 52, 61, or 70, and when the first shift amount is 86, the second shift amount associated with the first shift amount may be set to 95, 104, or 113. If this is the case, for example, (the first shift amount+9×N) may be used as the second shift amount (N=1, 2, 3). Note that, based on the first shift amount corresponding to the received PSS, the relay device 121 may specify the second shift amount corresponding thereto, and generate a new PSS using a sequence corresponding to the second shift amount. However, in this case, the relay device 121 may transform the newly generated PSS in a format that reflects the reception quality of the received PSS, i.e., in a format that does not lose the characteristics of the PSS received from the base station device 103, and transmit the transformed PSS. Note that the relay device 121 may transform the received PSS by applying a cyclic shift with a shift amount corresponding to the received PSS, and transmit the PSS corresponding to the second shift amount instead of generating a new PSS.

By detecting the peak of the value calculated through correlation detection performed using a known sequence, it is detected that a predetermined signal using the known sequence has been transmitted. In this regard, if another sequence is generated by applying a cyclic shift to a predetermined sequence, when correlation detection is performed using the predetermined sequence on the predetermined signal generated using the other sequence, a peak may occur at the time shifted by the time corresponding to the shift amount. At this time, if the difference between the predetermined sequences of the time at which the peak of the correlation detection occurs is within the range of the cyclic prefix added to one OFDM (orthogonal frequency division multiplexing) symbol, an error may occur in determining which shift amount the peak corresponds to. In other words, since it is assumed that a certain delay wave will occur for the OFDM symbol generated using a certain sequence, and a cyclic prefix is added for this purpose, when correlation detection is performed using this sequence, a peak corresponding to the delay wave will be detected within the range of the cyclic prefix. On the other hand, when correlation detection is performed using a different sequence obtained by applying a cyclic shift to this sequence, a peak will occur at a different time. At this time, if the shift amount of the cyclic shift is not large enough, the time difference will not be large enough and, for example, a peak may occur at a similar time as the delay wave. In this case, it is impossible to determine whether the peak that occurred corresponds to the sequence before the cyclic shift or the sequence after the cyclic shift. Therefore, in the present embodiment, the shift amount may be set so that the difference of the time at which the peak occurs exceeds the cyclic prefix interval of the PSS symbol intervals (OFDM symbol and cyclic prefix intervals). Note that this shift amount may also be applied to the relationship between two second sequences.

Note that such a shift amount is specified based on, for example, the length of the cyclic prefix added to an OFDM symbol. In an example, as described above, three shift amount patterns 9×N (N=1, 2, 3) used to generate the second sequence may be specified for one first sequence. If a plurality of second sequences are associated with one first sequence, each of the plurality of second sequences may be associated with a separate relay device. With this configuration, the terminal device 111 specifies one of the second sequences to which the received PSS corresponds, and can thus specify the relay device that has relayed the PSS. For example, if the delay time related to relay processing differs for each relay device, the time of reception can be corrected by a different amount of time depending on which relay device has relayed the PSS. As a result, it is possible to further improve the accuracy of position estimation by taking into account the differences in the characteristics of the relay devices.

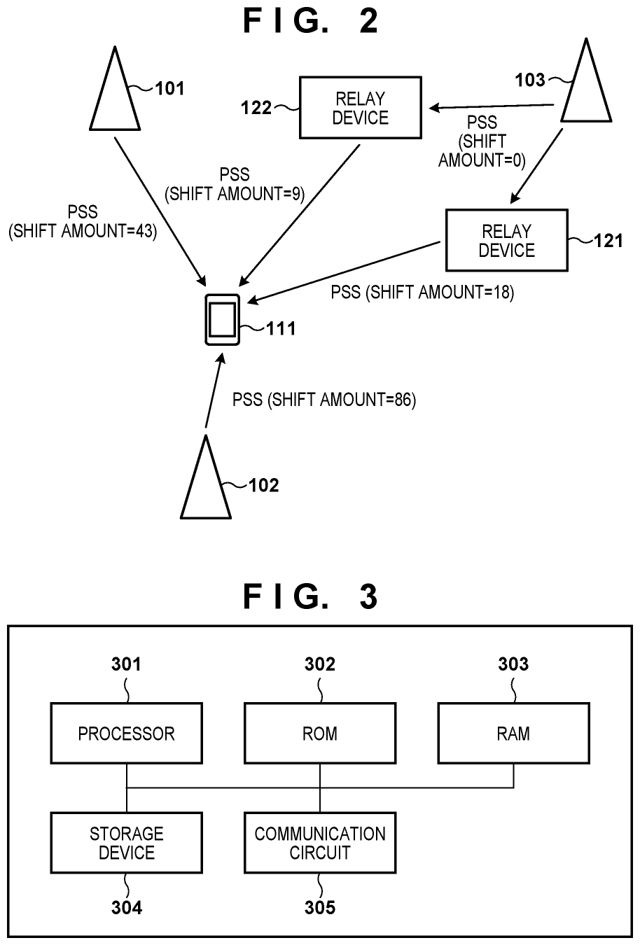

FIG. 2 shows an overview of the operations when such processing is performed. Here, it is assumed that the base station device 101, the base station device 102, and the base station device 103 transmit PSSs using sequences obtained by applying cyclic shifts with shift amounts of 43, 86, and 0 to the Zadoff-chu sequence, respectively. It is assumed that the first relay device 121 relays, for the received PSS, a PSS corresponding to a sequence to which a cyclic shift with a shift amount of 18 has further been applied, and the second relay device 122 relays, for the received PSS, a PSS corresponding to a sequence to which a cyclic shift with a shift amount of 9 has further been applied. That is to say, when the first relay device 121 receives a PSS that employs a sequence to which a cyclic shift with a shift amount of 43 has been applied, the first relay device 121 may output a PSS corresponding to a sequence obtained by applying a cyclic shift with a shift amount of 43+18=61 to the original Zadoff-chu sequence. When the second relay device 122 receives a PSS that employs a sequence to which a cyclic shift with a shift amount of 43 has been applied, the second relay device 122 may output a PSS corresponding to a sequence obtained by applying a cyclic shift with a shift amount of 43+9=52 to the original Zadoff-chu sequence. In FIG. 2, both the first relay device 121 and the second relay device 122 are configured to relay signals from the base station device 103. Therefore, since the base station device 103 transmits a PSS that employs a sequence to which a cyclic shift with a shift amount of 0 has been applied, the first relay device 121 and the second relay device 122 relay PSSs corresponding to sequences to which cyclic shifts with shift amounts of 18 and 9 have been applied, respectively.

Note that the shift amount in each relay device may be set in advance by receiving setting information from a base station device that is the target of relay processing, or through manual setting by a communication carrier, for example. In either case, information regarding the shift amount is shared between the base station device and each relay device. In addition, the base station device may hold information regarding time used to correct the time of reception, such as the time required for relay processing in each relay device. The base station device may report information indicating the time related to relay processing and the sequence shift amount for each relay device that relays the communication of the base station device, using system information (for example, SIB1), for example. Note that information that can specify the relay devices does not need to be reported. That is to say, it is sufficient that the terminal device 111 can recognize the relationship between the shift amount and the correction amount of the time of reception of a PSS. The terminal device 111 acquires this information, and based on which relay device has relayed the PSS transmitted from the base station device, the terminal device 111 can correct the time of reception by the amount of time corresponding to the relay processing performed in the relay device. Thus, the position estimation accuracy can be improved.

In FIG. 2, the terminal device 111 detects the PSS transmitted from the base station device 101, generated using the sequence obtained by applying a cyclic shift with a shift amount of 43 to the Zadoff-chu sequence. The terminal device 111 also detects the PSS transmitted from the base station device 102, generated using the sequence obtained by applying a cyclic shift with a shift amount of 86 to the Zadoff-chu sequence. These shift amounts are shift amounts when PSSs are directly transmitted from the base station devices, and therefore the terminal device 111 can determine that these PSSs have been received without going through a relay device. Note that the terminal device 111 can determine whether the PSS is transmitted from the base station device 101 or the base station device 102 based on whether the shift amount is 43 or 86. That is to say, the terminal device 111 can determine whether the detected PSS is transmitted from the base station device 101 or the base station device 102.

On the other hand, the terminal device 111 cannot detect the PSS transmitted from the base station device 103, generated using the Zadoff-chu sequence to which no cyclic shift is applied (the shift amount is 0). At this time, the first relay device 121 relays the PSS corresponding to the sequence obtained by applying a cyclic shift with a shift amount of 18 to the Zadoff-chu sequence as described above. The second relay device 122 relays the PSS corresponding to the sequence obtained by applying a cyclic shift with a shift amount of 9 to the Zadoff-chu sequence. As a result, the terminal device 111 can detect the PSSs corresponding to the sequences obtained by applying cyclic shifts with shift amounts of 9 and 18 to the Zadoff-chu sequence. Since the shift amounts for these PSSs are neither 0, 43, nor 86, the terminal device 111 can determine that these PSSs have been received via a relay device. When the shift amount is 9 or 18, the terminal device 111 can determine that a PSS corresponding to a sequence obtained by applying a cyclic shift with a shift amount of 0 to the Zadoff-chu sequence has been relayed by a relay device. Therefore, the terminal device 111 can determine that the PSS from the base station device 103 has been relayed by a relay device and arrived at the terminal device 111. In this case, the terminal device 111 corrects the time of reception of the PSS to indicate that the PSS directly arrives at the terminal device 111 from the base station device 103 earlier than the time at which the PSS is actually received by the time related to relay processing. Note that the time related to relay processing can be reported from the base station device 103 (via the relay device 121 or the relay device 122). In addition, for example, if the time related to relay processing is different in the first relay device 121 and the second relay device 122, the shift amount and information indicating the time may be associated with each other and reported to the terminal device 111. For example, information in which information indicating a first time related to the relay processing in the first relay device 121 and the shift amount=18 in the first relay device 121 are associated with each other is reported to the terminal device 111. For example, information in which information indicating a second time related to the relay processing in the second relay device 122 and the shift amount=9 in the second relay device 122 are associated with each other is reported to the terminal device 111. As a result, the terminal device 111 may treat the time earlier than the time of reception of the PSS corresponding to the Zadoff-chu sequence with the shift amount=18 by the first time, or the time earlier than the time of reception of the PSS corresponding to the Zadoff-chu sequence with the shift amount=9 by the second time, as the time of reception of the PSS from the base station device 103. Note that the terminal device 111 may treat an average time of the time earlier than the time of reception of the PSS corresponding to the Zadoff-chu sequence with the shift amount=18 by the first time and the time earlier than the time of reception of the PSS corresponding to the Zadoff-chu sequence with the shift amount=9 by the second time as the time of reception of the PSS from the base station device 103. As described above, the terminal device 111 can estimate the position thereof based on the time differences of arrival (TDOA), using the times of reception of the PSSs from the base station device 101 and the base station device 102 and the corrected time estimated as the time of reception of the PSS from the base station device 103. Position estimation based on TDOA is a conventional technique and will not be described here.

Note that the above PSSs are examples of predetermined signals, and other types of signals may be used. For example, newly defined signals may be used for position estimation. The first sequence and the second sequence need not necessarily be sequences generated by applying a cyclic shift to a predetermined sequence. That is to say, it is only necessary that a predetermined signal is generated using a sequence selected from predetermined candidates so that the signal can be detected by a terminal device, and the first sequence and the second sequence are different from each other and have a relationship in which one corresponding first sequence can be specified from the second sequence.

Note that, in order to perform the above-described processing, the relay device 121 has the function of specifying at least a predetermined signal, and transforming, amplifying, and outputting the predetermined signal. For example, the relay device 121 may specify a first sequence by performing demodulation processing on the received predetermined signal, apply a cyclic shift to the first sequence to generate a second sequence, and reproduce and relay a predetermined signal that is based on the second sequence. Note that, when the relay device 121 has specified the first sequence used to generate the received predetermined signal, the relay device 121 may transmit a predetermined signal separately prepared using a second sequence corresponding to the first sequence, instead of the received reference signal. Note that the relay device 121 may be configured to output a predetermined signal that is based on a transformed or separately prepared second sequence after a predetermined time has elapsed from the time of reception of a predetermined signal.

In addition, regarding a signal other than the predetermined signal, the relay device 121 may serve as a wireless repeater to amplify and relay the signal without performing demodulation processing on the signal. That is to say, the relay device 121 may have the function of performing the above-described processing on a predetermined signal, and serve as a wireless repeater that performs non-regenerative relay on other signals.

### Device Configuration

FIG. 3 is a diagram showing an example of a hardware configuration of the relay device 121. In one example, the relay device 121 includes a processor 301, a ROM 302, a RAM 303, a storage device 304, and a communication circuit 305. The processor 301 is a computer that includes one or more processing circuits such as a general-purpose CPU (central processing unit) or an ASIC (application-specific integrated circuit), and reads out and executes programs stored in the ROM 302 and the storage device 304 to perform processing for the entire device and each type of processing described above. The ROM 302 is a read-only memory that stores information such as programs and various parameters related to the processing performed by the relay device 121. The RAM 303 is a random access memory that functions as a work space when the processor 301 executes programs, and also stores temporary information. The storage device 304 is constituted by, for example, a removable external storage device or the like. The communication circuit 305 is constituted by, for example, a circuit for LTE or 5G wireless communication. Although FIG. 2 shows one communication circuit 305, the relay device 121 may include a plurality of communication circuits. For example, the relay device 121 may include wireless communication circuits and antennas for LTE and 5G.

Note that the terminal device 111 may have the same hardware configuration as that shown in FIG. 3.

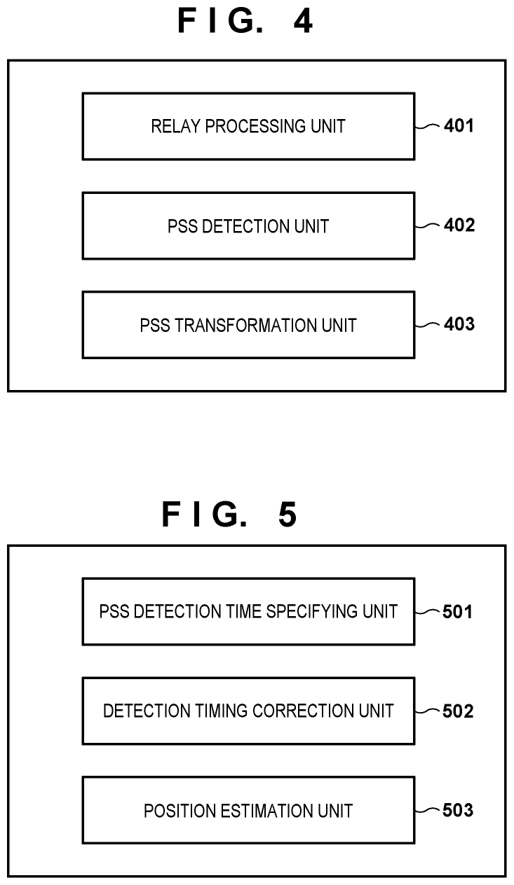

FIG. 4 is a diagram showing an example of a functional configuration of the relay device 121. The relay device 121 includes, for example, a relay processing unit 401, a PSS detection unit 402, and a PSS transformation unit 403. Note that these functional units can be implemented by, for example, the processor 301 executing a program stored in the ROM 302 or the storage device 304. However, the present invention is not limited to such a configuration, and for example, some or all of these functional units may be implemented using dedicated hardware. Since the processing to be performed by the relay device 121 has been described above, the functional configuration of the relay device 121 will only be roughly outlined here.

The relay processing unit 401 amplifies a signal received from the base station device 103 and transmits the amplified signal to the terminal device 111, or amplifies a signal received from the terminal device 111 and transmits the amplified signal to the base station device 103. The relay device 121 is, for example, a non-regenerative relay device (wireless repeater), and the relay processing unit 401 is configured to amplify signals other than predetermined signals used for positioning, such as PSSs, without demodulating or decoding the signals, and to output the signals (after performing frequency conversion on the signals, if necessary). When the relay device 121 is a regenerative relay device, the relay processing unit 401 may be configured to demodulate and decode the received signal, encode and modulate the resulting data sequence, and reproduce and output a wireless signal.

The PSS detection unit 402 performs PSS detection processing, using frequency and time resources where PSSs (predetermined signals) can be transmitted. For example, the PSS detection unit 402 performs correlation detection using the first sequence that can be used when the base station device 103 generates a PSS in the frequency and time resources, and if a peak appears in the correlation value, the PSS detection unit 402 may determine that the PSS has arrived. When a PSS is detected by the PSS detection unit 402, the PSS transformation unit 403 transforms the format of the PSS so that the terminal device 111 can determine that the PSS has arrived via the relay device 121. For example, the PSS transformation unit 403 may apply a cyclic shift with a predetermined shift amount to the first sequence corresponding to the received PSS, and output a PSS corresponding to the second sequence that is not to be used by the base station device 103 to transmit the PSS. Note that the PSS transformation unit 403 may newly generate a PSS using, for example, a second sequence corresponding to the first sequence used by the PSS detection unit 402 to detect a PSS. The modified or newly generated PSS output by the PSS transformation unit 403 is transmitted via the relay processing unit 401.

FIG. 5 is a diagram showing an example of a functional configuration of the terminal device 111. The terminal device 111 includes, for example, a PSS detection time specifying unit 501, a detection time correction unit 502, and a position estimation unit 503. Note that these functional units can be implemented by, for example, the processor 301 executing a program stored in the ROM 302 or the storage device 304. However, the present invention is not limited to such a configuration, and for example, some or all of these functional units may be implemented using dedicated hardware.

The PSS detection time specifying unit 501 detects PSSs that can be transmitted from the base station devices and PSSs that can be transferred from the relay devices, and specifies the times of detection of the PSSs. The PSS detection time specifying unit 501 uses, for example, a Zadoff-chu sequence to which a cyclic shift with a shift amount that allows each base station device to use the sequence to generate a PSS has been applied, to detect PSSs transmitted from the base station devices and specify the times of detection of the PSSs. Furthermore, the PSS detection time specifying unit 501 detects PSSs relayed by the relay devices, and specifies the times of detection thereof, using Zadoff-chu sequences whose shift amounts have been changed by the relay devices. The detection time correction unit 502, when a PSS relayed by a relay device is detected, corrects the detection time so as to indicate that the PSS has arrived earlier than the actual detection time by the time related to the relay processing performed by the relay device. Note that the time related to the relay processing performed by the relay device 121 can be the time required for the relay processing, but is not limited thereto. For example, the time corresponding to the expected value of the path difference between the straight-line distance from the position of the terminal device 111 to the position of the base station device and the distance of the path from the terminal device 111 to the base station device when a PSS is received via the relay device 121 may be included as the time related to the relay processing. For example, the positions of at least some of the terminal devices whose communications are relayed by the relay device 121 can be measured in advance using a GNSS or the like, and the expected value of the path difference can be specified from the distribution of the results. In one example, when a PSS is received through relay by the relay device 121, the time is corrected so as to indicate that the PSS has arrived at the base station device earlier than the actual time of reception by the expected value corresponding to this path difference.

The position estimation unit 503 performs positioning based on, for example, the time difference of arrival (TDOA). The position estimation unit 503 estimates the position of the terminal device 111 based on the differences between the times of detection of PSSs from a plurality of (for example, three) base station devices, which are obtained by the PSS detection time specifying unit 501 or the detection time correction unit 502. That is to say, when a PSS arrives at the terminal device 111 without being relayed by the relay device 121, the position estimation unit 503 performs position estimation based on the TDOA using the time at which the PSS is actually received, and when a PSS is received through the relay by the relay device 121, the position estimation unit 503 performs position estimation based on the TDOA using the corrected time.

### Processing Flow

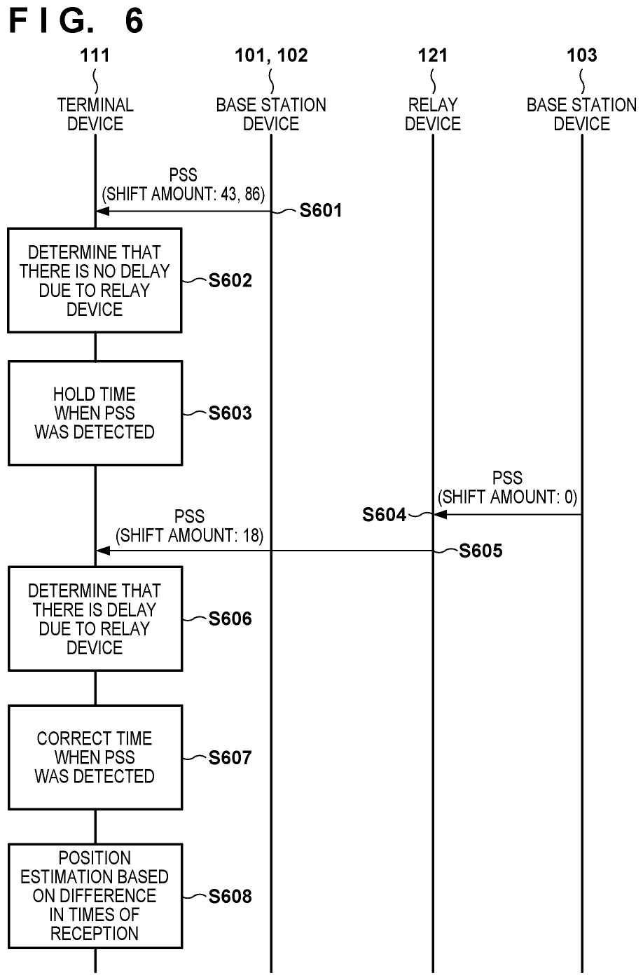

Next, an example of the flow of the processing performed in the wireless communication system will be described with reference to FIG. 6.

The base station device 101 generates a PSS using a sequence obtained by applying a cyclic shift with a shift amount of 43 to the Zadoff-chu sequence, for example, and broadcasts the PSS. The base station device 102 generates a PSS using a sequence obtained by applying a cyclic shift with a shift amount of 86 to the Zadoff-chu sequence, for example, and broadcasts the PSS (S601). It is assumed that the terminal device 111 can directly receive this PSS. The terminal device 111 detects the PSS from the base station device 101 by performing correlation detection using the sequence used by the base station device 101 to generate the PSS, and detects the PSS from the base station device 102 by performing correlation detection using the sequence used by the base station device 102 to generate the PSS. In this case, it is assumed that the terminal device 111 has successfully detected the PSSs by performing correlation detection using the sequences obtained by applying cyclic shifts with shift amounts of 43 and 86 to the Zadoff-chu sequence. In this case, the terminal device 111 determines that the PSSs from the base station device 101 and the base station device 102 have arrived without passing through any relay device (S602), and maintains the times of detection of the PSSs (S603). The terminal device 111 performs correlation detection using a sequence for which the shift amount in the case where a relay device is used has been changed. However, if there is no relay device nearby that relays signals from base station device 101 and base station device 102, the PSS corresponding to the sequence will not be detected.

On the other hand, similarly to the base station device 101 and the base station device 102, the base station a device 103 also generates a PSS using a sequence obtained without applying a cyclic shift to the Zadoff-chu sequence (with a shift amount of 0), for example, and broadcasts the PSS (S604). In contrast, the terminal device 111 is located at a position where it cannot directly receive the signal from the base station device 103, and even if the terminal device 111 performs correlation detection using the sequence used by the base station device 103 to generate the PSS, the terminal device 111 cannot detect the PSS. On the other hand, the terminal device 111 can detect the PSS transmitted from the base station device 103 and relayed by the relay device 121 by performing correlation detection using the sequence for which the shift amount in the case where the relay device is used has been changed (S605). That is to say, the terminal device 111 can detect the PSS by performing correlation detection using a sequence obtained by applying a cyclic shift with a shift amount of 18 to the Zadoff-chu sequence. In this case, the terminal device 111 determines that the PSS from the base station device 103 has arrived via the relay device 121 (S606), and corrects the time of detection of the PSS (S607). Thereafter, the terminal device 111 performs position estimation based on the TDOA, using the times of detection of the PSSs from the base station device 101 and the base station device 102 obtained in S603, and the corrected time of detection of the PSS from the base station device 103 obtained in S607 (S608). In order to simplify the description, the above example shows a case where the PSSs from base station device 101 and base station device 102 and the PSS from base station device 103 are detected at different times. However, these processing sequences may be performed in parallel.

As described above, in the present embodiment, the times of reception of the PSSs from the base station devices are determined by removing the influence of the delay caused by the relay processing performed by the relay device 121, which improves the accuracy of the estimation of the position of the terminal device 111. Therefore, it is possible to contribute to Goal 9 of the Sustainable Development Goals (SDGs) led by the United Nations: “build resilient infrastructure, promote sustainable industrialization and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A relay device that relays a wireless signal received from a base station device to a terminal device, the relay device comprising:
one or more processors; and
one or more memories that store a computer-readable instruction for causing, when executed by the one or more processors, the one or more processors to function as:
a control unit configured to control the relay device so that, when the relay device receives a predetermined signal generated using a first sequence from the base station device, the relay device relays to the terminal device the predetermined signal corresponding to a signal generated using a second sequence corresponding to the first sequence and not to be used by the base station device to generate the predetermined signal.

2. The relay device according to claim 1,
wherein the first sequence is a sequence obtained by applying a cyclic shift with a first shift amount to a predetermined sequence, or the predetermined sequence, and the second sequence is a sequence obtained by applying a cyclic shift with a second shift amount that is not to be used as the first shift amount, to the predetermined sequence.

3. The relay device according to claim 2,
wherein the second shift amount is a shift amount obtained by adding a predetermined shift amount to a value that can be used as the first shift amount.

4. The relay device according to claim 3,
wherein the predetermined shift amount is set based on a length of a cyclic prefix to be added to an orthogonal frequency division multiplexing (OFDM) symbol.

5. The relay device according to claim 1,
wherein the predetermined signal is a primary synchronization signal (PSS).

6. The relay device according to claim 1,
wherein, when receiving a signal different from the predetermined signal from the base station device, the relay device amplifies and transfers the signal to the terminal device without performing demodulation processing on the signal.

7. A terminal device comprising:
one or more processors; and
one or more memories that store a computer-readable instruction for causing, when executed by the one or more processors, the one or more processors to function as:
a detection unit configured to detect a predetermined signal arriving at the terminal device; and
an estimation unit configured to estimate a position of the terminal device based on the predetermined signal thus detected and a position of a base station device from which the predetermined signal is transmitted,
wherein,
when the predetermined signal generated using a first sequence is detected, the estimation unit estimates the position of the terminal device using a time of detection of the predetermined signal, and
when the predetermined signal corresponding to a signal generated using a second sequence related to the first sequence and not to be used by the base station device to generate the predetermined signal is detected, the estimation unit estimates the position of the terminal device by correcting the time of detection so as to indicate that the predetermined signal has arrived at the terminal device earlier than the time of detection of the predetermined signal by a time related to relay processing performed by a relay device.

8. The terminal device according to claim 7, wherein the computer-readable instruction causes, when executed by the one or more processors, the one or more processors to further function as an acquisition unit configured to acquire information indicating the time related to the relay processing from the base station device.

9. The terminal device according to claim 8,
wherein the acquisition unit acquires the information indicating the time related to the relay processing from system information reported by the base station device.

10. The terminal device according to claim 8,
wherein, when a plurality of relay devices are present, the acquisition unit acquires the information indicating the time related to the relay processing for each of the plurality of relay devices.

11. The terminal device according to claim 10,
wherein different second sequences respectively correspond to the plurality of relay devices, and
when the estimation unit detects the predetermined signal corresponding to a signal generated using one of the second sequences, the estimation unit corrects the time of detection by a time related to relay processing performed by one of the plurality of relay devices corresponding to the one of the second sequences.

12. A control method carried out by a relay device that relays a wireless signal received from a base station device to a terminal device, the control method comprising:
performing control so that, when a predetermined signal generated using a first sequence is received from the base station device, the predetermined signal corresponding to a signal generated using a second sequence corresponding to the first sequence and not to be used by the base station device to generate the predetermined signal is relayed to the terminal device.

13. A control method carried out by a terminal device, the control method comprising:
detecting a predetermined signal arriving at the terminal device; and
estimating a position of the terminal device based on the predetermined signal thus detected and a position of a base station device from which the predetermined signal is transmitted,
wherein, in the estimation of the position of the terminal device,
when the predetermined signal generated using a first sequence is detected, the position of the terminal device is estimated using a time of detection of the predetermined signal, and
when the predetermined signal corresponding to a signal generated using a second sequence related to the first sequence and not to be used by the base station device to generate the predetermined signal is detected, the position of the terminal device is estimated by correcting the time of detection so as to indicate that the predetermined signal has arrived at the terminal device earlier than the time of detection of the predetermined signal by a time related to relay processing performed by a relay device.

14. A non-transitory computer-readable storage medium that stores a program for causing a computer included in a relay device that relays a wireless signal received from a base station device to a terminal device to execute a control method, wherein the control method comprises:
performing control so that, when a predetermined signal generated using a first sequence is received from the base station device, the predetermined signal corresponding to a signal generated using a second sequence corresponding to the first sequence and not to be used by the base station device to generate the predetermined signal is relayed to the terminal device.

15. A non-transitory computer-readable storage medium that stores a program for causing a computer included in a terminal apparatus to execute a control method, wherein the control method comprises:
detecting a predetermined signal arriving at the terminal device; and
estimating a position of the terminal device based on the predetermined signal thus detected and a position of a base station device from which the predetermined signal is transmitted,
wherein, in the estimation of the position of the terminal device,
when the predetermined signal generated using a first sequence is detected, the position of the terminal device is estimated using a time of detection of the predetermined signal, and
when the predetermined signal corresponding to a signal generated using a second sequence related to the first sequence and not to be used by the base station device to generate the predetermined signal is detected, the position of the terminal device is estimated by correcting the time of detection so as to indicate that the predetermined signal has arrived at the terminal device earlier than the time of detection of the predetermined signal by a time related to relay processing performed by a relay device.
